(19) United States
(12) Patent Application Publication
(10) Pub. No.: US 2023/0036295 A1
(43) Pub. Date: Feb. 2, 2023

(54) MONITORING OF A LASER MACHINING PROCESS USING A NEUROMORPHIC IMAGE SENSOR

(71) Applicant: Precitec GmbH & Co. KG, Gaggenau (DE)

(72) Inventors: Fabian Mack, Karlsruhe (DE); Matthias Sauer, Karlsruhe (DE)

(21) Appl. No.: 17/791,788

(22) PCT Filed: Nov. 10, 2020
(86) PCT No.: PCT/EP2020/081633

§ 371 Date: Jul. 8, 2022

(30) Foreign Application Priority Data
Jan. 9, 2020 (DE) 10 2020 100 345.5

(51) Int. Cl. B23K 26/03; B23K 26/21; B23K 26/38; B23K 31/00; B23K 31/12

(52) U.S. Cl. CPC B23K 26/032; B23K 26/21; B23K 26/38; B23K 31/006; B23K 31/125

(57) ABSTRACT

A system for monitoring a laser machining process on a workpiece is disclosed. The system includes: a neuromorphic image sensor configured to generate image data of the laser machining process, and a computing unit configured to determine input data based on the image data, and to determine output data based on the input data by means of a transfer function, the output data containing information about the laser machining process. Further, a method for monitoring a laser machining process on a workpiece is disclosed.

### CROSS-REFERENCE TO RELATED APPLICATIONS

This application is the U.S. National Stage of PCT/EP2020/081633 filed on Nov. 10, 2020, which claims priority to German Patent Application 102020100345.5 filed on Jan. 9, 2020, the entire content of both are incorporated herein by reference in their entirety.

### FIELD OF THE INVENTION

The present disclosure relates to a system for monitoring a laser machining process for machining a workpiece using a laser beam and a laser machining system for machining a workpiece using a laser beam, which includes such a system. Furthermore, the present disclosure relates to a method for monitoring a laser machining process for machining a workpiece.

### BACKGROUND OF THE INVENTION

In a laser machining system for machining a workpiece using a laser beam, the laser beam emerging from a laser light source or from one end of a laser optical fiber is focused or collimated onto the workpiece to be machined using beam guiding and focusing optics. Machining may comprise laser cutting or welding, for example. The laser machining system may include a laser machining head, for example. When laser machining a workpiece, it is important to monitor and control the machining process and to ensure the quality of the machining.

This is carried out, for example, by capturing images or a video of a machining area of the workpiece surface (also called “process zone”) and subsequent image processing and evaluation during the laser machining process for monitoring or after completion of the laser machining process for quality assurance. In particular, the machining area may include a vapor capillary (also called a “keyhole”) and the melt pool surrounding the vapor capillary.

So-called “frame-based cameras” are usually used for this purpose. Frame-based cameras are based on the principle that the entire image sensor of the camera is exposed at a specific point in time or at specific time intervals. This creates a single image of the workpiece surface that is associated with the respective point in time. A plurality of such individual images are transmitted completely and sequentially to a computing unit for further image processing and evaluation, or are stored. A single image is also referred to as a “frame”. A property of frame-based cameras relates to the number of frames per second that can be captured by the respective camera and is specified in “frames per second” or “fps” for short. When capturing images with a frame-based camera, all the information of each pixel is captured and transmitted, which leads to an enormous redundancy in the information generated and transmitted in the case of relatively small changes in the image, for example,. This in turn results in a large amount of image data being generated and transmitted.

Both during (“online”) and after (“offline”) the performance of a laser machining process, the image data generated in this way are used as input data for image processing and evaluation using various methods or algorithms. On the one hand, the image data may be used offline to determine optimal parameters for different steps of the laser machining process, in particular piercing, cutting, welding, in order to improve the individual steps in the next stage. On the other hand, the data may be used in combination with various models and algorithms to monitor the result of the laser material machining process or to determine whether there is a machining error and what type of machining error there is. The image data may be used online to monitor and/or control the laser machining process by influencing parameters of the laser machining process.

In order to achieve sufficiently good results with these methods, the image data must meet certain quality requirements. In the field of laser machining processes and systems, however, this is difficult for a number of reasons.

On the one hand, the difficult lighting conditions that prevail during the laser machining process may become a problem. In particular, the lighting conditions may change constantly and/or abruptly. Therefore, in order to generate images or videos suitable for monitoring with frame-based cameras, additional illumination is generally required, often in combination with a high-quality bandpass filter particularly transparent at the wavelength of the illumination, in order to generate usable image data.

In addition, the machines used in the laser machining system are constantly becoming faster. In particular, the individual steps of a laser machining process may be carried out faster and faster in order to produce more profitably. This means that the fps value of frame-based cameras has to increase, which is why the exposure times for a single frame have to become shorter and shorter. The dynamic range of frame-based cameras is limited. On the other hand, this leads to an enormous increase in the image data generated and to be processed.

### SUMMARY OF THE INVENTION

It is an object of the invention to enable monitoring and/or control of a laser machining process, in particular in real time. In particular, it is an object of the invention to enable control of at least one parameter of the laser machining process.

It is a further object of the invention to reduce the computing power, system costs and/or power consumption required for monitoring a laser machining process. It is also an object of the invention to reduce the volume of image data generated and transmitted when monitoring a laser machining process.

It is a further object of the invention to improve the monitoring of a laser machining process without additional illumination units.

These objects are achieved by the subject matter disclosed herein. Advantageous embodiments and further developments are also disclosed.

The invention is based on the basic idea of using neuromorphic image sensors to monitor a laser machining process, such as laser cutting or laser welding. The neuromorphic image sensor may also be referred to as an “event-based image sensor” and may be configured in particular as an event-based camera. Accordingly, monitoring with a neuromorphic image sensor may be referred to as “event-based monitoring”. Neuromorphic image sensors have a larger dynamic range and a higher equivalent frame rate and thus a higher temporal resolution than frame-based cameras. Furthermore, no redundant information or image data is generated or transmitted. The use of neuromorphic image sensors thus allows for improved monitoring and/or control of laser machining processes, in particular in real time. In particular, monitoring of rapidly performed laser machining processes is improved. At the same time, the computing power required for image processing or evaluation can be reduced and the power consumption can be reduced. Furthermore, no separate illumination of the laser machining process is required. Due to the reduced computing power and the reduced power consumption, the computing units used for image processing and evaluation can be made smaller or more compact and can be integrated into a laser machining head, for example, which means that system costs, in particular production costs, can be reduced.

Moreover, the neuromorphic image sensors can also be combined with machine learning (“ML” for short) methods or algorithms.

According to an aspect of the present invention, a system for monitoring a laser machining process for machining a workpiece using a laser beam is provided, said system comprising: a neuromorphic image sensor configured to generate image data of the laser machining process, in particular of a surface of the workpiece, and a computing unit configured to determine input data based on the image data, and to determine output data based on the input data by means of a transfer function, said output data containing information about the laser machining process. The output data may be used for quality monitoring and/or control of the laser machining process.

According to a further aspect of the present invention, a laser machining system for machining a workpiece using a laser beam is provided, said laser machining system comprising: a laser machining head for radiating a laser beam onto a workpiece to be machined; and the system described above for monitoring a laser machining process.

According to a further aspect of the present invention, a method for monitoring a laser machining process for machining a workpiece using a laser beam is provided, said method comprising the steps of: generating image data of the laser machining process my means of a neuromorphic image sensor, determining input data based on the image data, and determining output data based on the input data using a transfer function, said output data containing information about the laser machining process. The method preferably also comprises the step of controlling, in particular in real time, at least one parameter of the laser machining process based on the determined output data. The method may comprise controlling, in particular in real time, at least one parameter of the laser machining process based on the determined output data.

The workpiece surface, the laser machining process, and the vapor of the melting material can be visualized or mapped using the neuromorphic image sensor. In an embodiment, the spectral sensitivity of the neuromorphic image sensor may be in the visible range and/or in the border area between the visible range and the infrared range.

The computing unit of the system may be configured to execute the method described above for monitoring a laser machining process. In other words, the method may be executed by the computing unit.

The transfer function between the input data and the output data may be formed by a trained neural network. The computing unit may therefore use the transfer function to carry out image processing or image evaluation of the image data transmitted by the neuromorphic sensor.

The computing unit may be configured to generate the input data via a further transfer function based on the image data. The additional transfer function may be formed by an additional trained neural network. The further transfer function may be used to reduce the amount of image data. Alternatively, the image data transmitted from the neuromorphic image sensor may be the input data or used as input data.

The trained neural network and/or the further trained neural network may be convolutional neural networks, CNN, binarized neural networks, BNN, and/or recurrent neural networks, RNN.

The neuromorphic image sensor may be configured to generate image data from a workpiece surface. In particular, the neuromorphic image sensor may be configured to generate image data from a machining area of the workpiece surface. The machining area of the workpiece surface may include a process zone, in particular a vapor capillary and/or a melt pool. The neuromorphic image sensor may further be configured to generate an area that is in advance of the machining area in a forward direction and/or that is in the wake of the machining area in a forward direction.

The neuromorphic image sensor may be configured to transmit image data to the computing unit continuously and/or asynchronously. In particular, the neuromorphic image sensor may be configured to transmit a continuous stream of image data to the computing unit. The continuous stream of image data may be in the form of an asynchronous stream of event-based image data.

The neuromorphic image sensor may include a plurality of pixels that independently generate image data in response to changes in brightness sensed by each pixel. The image data of a pixel may include at least one pixel address corresponding to the pixel and a time stamp corresponding to the detected change in brightness. The image data of a pixel may also include a polarity of the brightness change and/or a brightness level. The neuromorphic image sensor may have spectral sensitivity in the visible range.

The neuromorphic image sensor may be configured to independently detect a change in an exposure level, i.e. a change in brightness, of each of the plurality of pixels and to transmit it to the computing unit as a so-called event. In other words, the neuromorphic image sensor may include a plurality of pixels that independently detect changes in brightness and pass them on as an event as soon as the changes in brightness occur. The pixels may be configured not to generate or transmit image data otherwise. Accordingly, the continuous stream of image data may include individual events transmitted asynchronously.

The information about the laser machining process may include information about a state of the laser machining process, information about a machining result, a machining error and/or a machining area of the workpiece. The machining result may, in particular, be a current machining result. The information about a machining error may include at least one of the following information: presence of at least one machining error, type of machining error, position of the machining error on a surface of a machined workpiece, probability of a machining error of a certain type, and spatial and/or areal extent of the machining error the surface of the machined workpiece.

The computing unit may be configured to form the output data in real time.

The system for monitoring the laser machining process, in particular the computing unit of the system, may include a communication interface for transmitting or receiving data.

The computing unit may be configured to generate control data based on the output data and to output or transmit said data to the laser machining system. Alternatively, the computing unit may be configured to transmit the output data to the laser machining system.

The system for monitoring the laser machining process may be integrated into an existing laser machining system. The computing unit may be arranged on or in the laser machining head. The computing unit of the system may also be integrated in a control unit of the laser machining system. The neuromorphic image sensor may be arranged on an outside and/or on the laser machining head. The beam path of the neuromorphic image sensor may be at least partially integrated into the beam path of the laser machining system or the laser machining head, and e.g. extend at least partially coaxially.

The laser machining system may include a control unit configured to control the laser machining system and/or to control the laser machining process based on the output data determined by the computing unit, preferably in real time. The laser machining process may be controlled by setting, adapting and/or changing at least one parameter of the laser machining process. Parameters of the laser machining process are, for example, laser power, focal position, feed speed and direction, focus diameter, distance between the laser machining head and the workpiece, etc. The laser machining system may include a laser source configured to generate the laser beam for laser machining. In this case, the control unit may be configured to control the laser source.

The computing unit may further be configured to transmit the determined output data to a unit for quality assurance of the laser machining system. The quality assurance unit may be configured to determine optimal parameters for at least one step of the laser machining process or for a subsequent laser machining process based on the initial data.

The present invention may advantageously be used to control a laser machining process, in particular laser cutting or laser welding. Due to the high dynamic range of the sensor in combination with the high temporal resolution of the same, parameters of the laser machining process may be adapted to the current process status, preferably in real time, thereby achieving better machining results. These include, for example, a better surface quality, an increased feed rate and a shorter piercing time. During laser cutting, for example, the piercing process may be analyzed in real time and controlled precisely. In addition, during laser cutting, a cutting front may be monitored and the process quality may be determined in real time. Furthermore, the present invention allows for spatter to be monitored with an extremely high temporal resolution, which can be used both in laser cutting and in laser welding in order to draw conclusions about the process quality. In laser welding, the present invention enables direct monitoring of the weld pool and control of laser welding parameters.

Due to the high temporal resolution and the high dynamics of the neuromorphic image sensor and the reduced amount of data due to the event-based data generation, a laser machining process can be monitored and/or controlled more efficiently and quickly. In particular, the combination of a neuromorphic image sensor (event-based sensor) and machine learning allows for an immediate analysis of the process state and real-time control of the process in a cost-effective and compact manner.

### DETAILED DESCRIPTION OF THE DRAWINGS

Embodiments of the invention are described in detail below with reference to figures, wherein:

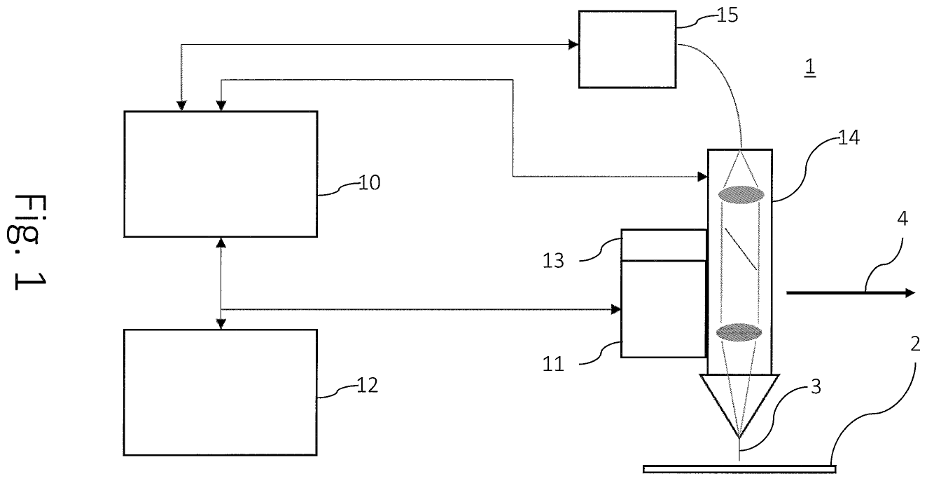

FIG. 1 shows a schematic diagram of a laser machining system for machining a workpiece using a laser beam and a system for monitoring a laser machining process according to a first embodiment;

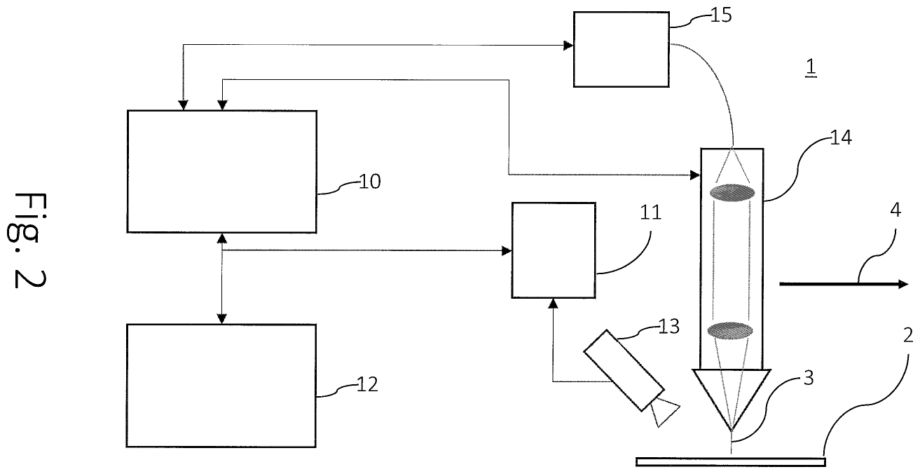

FIG. 2 shows a schematic diagram of a laser machining system for machining a workpiece using a laser beam and a system for monitoring a laser machining process according to a second embodiment; and

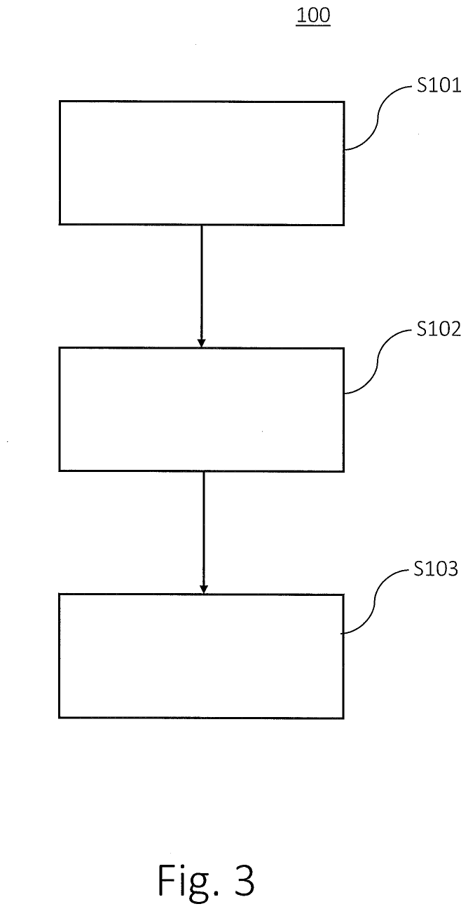

FIG. 3 shows a flow diagram of a method for monitoring a laser machining process for machining a workpiece according to an embodiment.

### DETAILED DESCRIPTION OF THE INVENTION

Unless otherwise noted, the same reference symbols are used below for elements that are the same or have the same effect.

FIG. 1 shows a schematic diagram 1 of a laser machining system for machining a workpiece using a laser beam and a system for monitoring a laser machining process according to a first embodiment and FIG. 2 shows a schematic diagram of a laser machining system for machining a workpiece using a laser beam and a system for monitoring a laser machining process according to a second embodiment.

A laser machining system 1 is configured to machine a workpiece 2 using a laser beam 3. The laser machining system 1 includes a laser machining head 14, such as a laser cutting or laser welding head, and a laser device 15, also called a “laser source”, for providing the laser beam 3. The laser machining head 14 is configured to radiate the laser beam 3 onto the workpiece 2. The laser machining head 14 may comprise collimating optics for collimating the laser beam and/or focusing optics for focusing the laser beam 3. The area of the workpiece surface on which the laser beam 3 is incident on the workpiece 2 may also be referred to as the “machining area” or “process zone” and may in particular include a puncture hole, a vapor capillary and/or a melt pool.

The laser machining system 1 or parts thereof, in particular the laser machining head 14, and the workpiece 2 may be movable relative to one another in a machining or feed direction 4. For example, the laser machining system 1 or parts thereof, in particular the laser machining head 14, may be moved in the feed direction 4. Alternatively, the workpiece 2 may be moved in the feed direction 4 relative to the laser machining system 1 or to a part thereof, in particular relative to the laser machining head 14. The feed direction 4 may be a cutting or welding direction. In general, the feed direction 4 is a horizontal movement. The speed at which the laser machining system 1 and the workpiece 2 move relative to each other along the feed direction 4 may be referred to as “feed speed”.

The laser machining system 1 is configured to perform a laser machining process such as laser cutting and laser welding. The laser machining system 1 includes a control unit 10 configured to control the machining head 14 and/or the laser device 15. The control unit 10 may be configured to control the laser machining process. The control includes changing, adjusting or setting at least one parameter of the laser machining process. The at least one parameter may include, for example, the laser power of the laser device 15, the feed rate of the laser machining head 14, and the focal position of the laser beam 3.

The laser machining system 1 further includes a system for monitoring a laser machining process. The system for monitoring a laser machining process includes a neuromorphic image sensor 13 and a computing unit 11.

The neuromorphic image sensor 13 is configured to generate image data of the laser machining process or of a surface of the workpiece 2. The computing unit 11 is configured to determine input data based on the image data and to determine output data based on the input data using a transfer function, said output data containing information about the laser machining process. The computing unit 11 may be configured to form the output data in real time. The computing unit 11 or the control unit 10 may be configured to execute the method described below for monitoring a laser machining process. In other words, the method may be executed by the computing unit 11 or the control unit 10.

The neuromorphic image sensor 13 is based on the principle of only outputting or recording the change in exposure level of each individual pixel. Neuromorphic image sensors, also known as event-based image sensors, sense changes in brightness, so-called “events”. The data transfer takes place in asynchronous form. In event-based image sensors or event-based cameras, there is a continuous transmission of information regarding changes in brightness. Only the information from the pixels that have detected changes in brightness is continuously transmitted. In comparison to frame-based cameras, in which the brightness values for all pixels (including those that have not changed compared to the previous image) are transmitted with each image, neuromorphic image sensors only transmit data when the brightness of a pixel changes significantly. The temporal quantification of the individual pixels results in fewer redundancies than in frame-based image sensors or cameras. At the same time, the loss of information is lower.

Neuromorphic image sensors have a number of advantages. These include a high dynamic range, e.g. from approx. 100 to 130 dB, so that additional illumination is not required in most cases. In addition, neuromorphic image sensors have a high temporal resolution and are not affected by overexposure/underexposure or fast movement. The recording speed of the neuromorphic image sensors is comparable to that of a high-speed camera, which may have several thousand fps, although with neuromorphic image sensors there are no frames but a continuous data stream. The neuromorphic image sensor 13 may have, for example, a dynamic range of approximately 120 dB, a temporal resolution in the microsecond range, an equivalent frame rate of 1000000 fps, and/or a spatial resolution of 0.1-0.2 MP.

Due to the greatly reduced amount of data, the computing unit 11 requires significantly less computing power and may therefore move closer to the location of the image data generation, i.e. the neuromorphic image sensor 13.

According to the embodiment shown in FIG. 1, it is therefore possible to integrate the computing unit 11 directly into the laser machining head 14 or to mount it on the laser machining head. This allows system costs to be reduced. At the same time, cables can be omitted and/or distances of transmission via cables can be reduced, as a result of which the susceptibility to errors can be reduced and the ease of maintenance can be increased. As shown, the neuromorphic image sensor 13 is also mounted on the laser machining head 14 or integrated into the laser machining head 14. In the embodiment shown in FIG. 1, the computing unit 11 is arranged on the laser machining head 14 and the neuromorphic image sensor 13 is arranged on an outside of the laser machining head 14. According to the embodiment shown, a beam path of the neuromorphic image sensor 13 extends at least partially within the laser machining head 14 and/or coaxially with the laser beam 3.

In contrast, according to the embodiment shown in FIG. 2, the computing unit 11 is configured as an independent or separate unit from the laser machining head 14 and from the neuromorphic image sensor 13. The beam path of the neuromorphic image sensor 13 extends outside of the laser machining head 14. However, the neuromorphic image sensor 13 may be attached to the laser machining head 14.

According to embodiments, the computing unit 11 may be combined with or integrated into the control unit 10. In other words, the functionality of the computing unit 11 may be combined with that of the control unit 10.

The neuromorphic image sensor 13 is configured to generate image data from the workpiece surface and is in particular configured to generate image data from the machining area of the workpiece surface. According to embodiments, the neuromorphic image sensor 13 may be configured in particular to generate image data from an area in advance of the process zone in the feed direction 4 and/or an area in the wake of the process zone in the feed direction 4.

The image data of a pixel include, for example, the pixel address or the pixel identity and a time stamp. In addition, the image data may also include the polarity (increase or decrease) of the brightness change or a level of the brightness sensed now.

The information about the laser machining process, which is contained in the output data determined by the computing unit 11, may include information about a state of the laser machining process, information about a machining result, a machining error and/or a machining area of the workpiece 2. In particular, the machining result may be a current machining result.

Due to the high recording speed, processing the image data of the neuromorphic image sensor 13 with conventional image processing algorithms entails a loss of performance. Therefore, embodiments of the present invention preferably use machine learning methods for image data processing or for image data evaluation. For example, the transfer function between the input data and the output data may be formed by a trained neural network. The transfer function may be used for image processing or image evaluation of the input data. Advantageously, so-called “CNNs” may be used for image processing and evaluation, “BNNs” for reducing the amount of image data, and “RNNs” for the temporal analysis of the events. In this way, in particular, a loss of performance compared to conventional methods of image processing or evaluation can be avoided. For example, the image data is not converted into frames, but transferred to a suitable vector space, for example by spatio-temporal filtering in the spike event domain.

With the aid of the neuromorphic image sensors, smaller models compared to frame-based cameras can be used in machine learning methods while achieving comparable performance. Due to the elimination of redundant information in neuromorphic image sensors, the machine learning model has to take fewer features into account, which in the case of a neural network is equivalent to a reduction in the number of neurons contained in the network. This makes it much easier to train the machine learning models since smaller models usually require far fewer examples to train the model. The omission of redundant information also allows for faster execution of the transfer function or the algorithm (“inference”) for image processing or image analysis. In this way, in particular real-time control of the laser machining process becomes possible.

According to embodiments, the computing unit 11 may be configured to generate control data based on the output data and to transmit them to the control unit 10. Alternatively, the output data are transmitted to the control unit 10 and the control unit 10 may be configured to generate control data. The control unit 10 may further be configured to control and/or regulate the laser machining system or the laser machining process, preferably in real time, based on the output data determined by the computing unit 11. For example, the control unit 10 may be configured to control the laser machining head 14 and/or the laser source 15 based on the output data.

The computing unit 11 may further be configured to transmit the output data determined to a quality assurance unit 12 of the laser machining system. The quality assurance unit 12 may be configured to determine optimum parameters for at least one step of the laser machining process based on the initial data and to transmit them to the control unit 10.

FIG. 3 shows a flow diagram of a method for monitoring a laser machining process for machining a workpiece according to an embodiment.

The method 100 comprises the steps of: generating image data of the laser machining process using a neuromorphic image sensor (S101), determining input data based on the image data (S102), and determining output data based on the input data using a transfer function, the output data being information about the laser machining process (S103).

The method may also include controlling, in particular in real time, at least one parameter of the laser machining process based on the determined output data. The parameter may include the laser power of the laser source, a feed rate and a focal position.

The present invention may advantageously be used to control a laser machining process. The output data are preferably transmitted from the computing unit 11 directly to the control unit 10, which may also be referred to as “machine control”. The control unit 10 may be configured to control at least one parameter of the laser machining process or the laser machining system, in particular in real time, based on the output data. The parameter may include the laser power of the laser source, a feed rate and a focal position. This allows for the parameters to be adjusted to the current process status in real time, which means that better machining results can be achieved. These include, for example, better surface quality and an increased feed rate and a shorter piercing time when laser cutting.

When laser cutting, for example, the piercing process can be analyzed and controlled in real time thanks to the extremely high equivalent frame rate and the resulting high temporal resolution of the camera. In addition, the high dynamic range of the sensor in combination with the high temporal resolution can be used to monitor the cutting front during a laser cutting process and the process quality can be determined in real time. As a result, the cutting process can be controlled, for example, by counteracting, in the event of reduced process quality, by changing, adapting or controlling the parameters of the laser machining process, in particular laser power, feed rate and focal position. The present invention also makes it possible to monitor spatter with an extremely high temporal resolution during laser cutting or laser welding in order to draw conclusions about the process quality. In laser welding, the present invention allows for direct monitoring of the weld pool and control of laser welding parameters.

1. A system for monitoring a laser machining process on a workpiece, said system comprising:
a neuromorphic image sensor configured to generate image data from a surface of the workpiece; and
a computing unit configured to determine input data based on the image data, and to determine output data based on the input data by means of a transfer function, said output data containing information about the laser machining process.

2. The system according claim 1, wherein said neuromorphic image sensor is configured to generate image data from a machining area, an area in advance of the machining area and/or an area in the wake of the machining area.

3. The system according to claim 1, wherein said neuromorphic image sensor is configured to transmit image data to said computing unit continuously and/or asynchronously.

4. The system according to claim 1, wherein said neuromorphic image sensor comprises a plurality of pixels configured to generate image data independently of one another in response to changes in brightness sensed by the respective pixel.

5. The system according to claim 4, wherein the image data of a pixel comprise at least a pixel address corresponding to the pixel and a time stamp corresponding to the sensed change in brightness.

6. The system according to claim 1, wherein said computing unit is configured to generate the input data by means of a further transfer function based on the image data, and/or wherein the image data transmitted from said neuromorphic image sensor are the input data.

7. The system according to claim 1, wherein the transfer function between the input data and the output data and/or the further transfer function between the image data and the input data is formed by a trained neural network.

8. The system according to claim 7, wherein the trained neural network comprises a convolutional neural network, CNN, a binary neural network, BNN, and/or a recurrent neural network, RNN.

9. The system according to claim 1, wherein the information about the laser machining process includes information about a state of the laser machining process, about a machining result, about a machining error and/or about a machining area of said workpiece.

10. The system according to claim 1, wherein the computing unit is configured to output the output data as control data for a laser machining system carrying out the laser machining process.

11. A laser machining system for machining a workpiece using a laser beam, said laser machining system comprising:
a laser machining head for radiating a laser beam onto said workpiece; and
the system according to claim 1.

12. The laser machining system according to claim 11, wherein said computing unit is arranged on or in said laser machining head, and/or wherein said neuromorphic image sensor is arranged on an outside of said laser machining head and/or on said laser machining head.

13. The laser machining system according to claim 1, further comprising:
a laser source configured to generate the laser beam; and
a control unit configured to control, based on the output data determined by said computing unit, said laser machining system and/or said laser machining head and/or said laser source and/or to control the laser machining process.

14. A method for monitoring a laser machining process on a workpiece, said method comprising the steps of:
generating image data from a surface of said workpiece using a neuromorphic image sensor;
determining input data based on the image data; and
determining output data based on the input data by means of a transfer function, said output data containing information about the laser machining process.

15. The method according to claim 14, further comprising the step of:
controlling, in real time, at least one parameter of the laser machining process based on the determined output data.
